(19) United States
(12) Patent Application Publication
(10) Pub. No.: US 2026/0016043 A1
(43) Pub. Date: Jan. 15, 2026

(54) COATED CONNECTOR DEVICES AND METHODS OF MAKING AND USING THEREOF

(71) Applicant: Carbice Corporation, Atlanta, GA (US)

(72) Inventors: Baratunde Cola, Atlanta, GA (US); Craig Green, Atlanta, GA (US); Erik Anderson, Atlanta, GA (US)

(21) Appl. No.: 19/268,289

(22) Filed: Jul. 14, 2025

Related U.S. Application Data
(60) Provisional application No. 63/671,516, filed on Jul. 15, 2024.

(51) Int. Cl. F16B 39/24

(52) U.S. Cl. CPC F16B 39/24

(57) ABSTRACT

Connectors devices having one or more coatings formed of elastic coating materials thereon, as well as methods of making and using thereof are described herein. Such coated connector devices can be used in various applications, such as in forming joints which are subjected to loads and stresses.

### CROSS-REFERENCED TO RELATED APPLICATIONS

This application claims the benefit of and priority to U.S. Provisional Application No. 63/671,516, filed Jul. 15, 2024, which is hereby incorporated herein by reference in its entirety.

### FIELD OF THE INVENTION

This invention is in the field of connector devices, particularly connectors coated with an elastic coating material, as well as methods of making and using thereof.

### BACKGROUND OF THE INVENTION

Currently, load distribution devices, such as washers, are subject to expansion and contraction when used in joints that are thermally cycled. However, such load distribution devices may lack the elastic compression needed to accommodate the mismatch in expansion between the structural elements at such a joint. For instance, in bus bar bolted connections, the bolt material is commonly steel. A difference between the thermal expansion coefficients of the bolt material to that of the bar material (e.g. Al or Cu) can create a contrast between the expansion or contraction rate of the bolted connection when the temperature is increased or decreased. The difference in expansion rates can either reduce the clamping force of the load distribution device or produce increased forces on the joint that lead to creep, relaxation, and permanent deformation. Thus, temperature fluctuations and vibrations can result in loosening at such joints. Although known load distribution devices, like washers, may be able to prevent load losses, at high loads these materials are typically outside of their elastic range, and it is difficult to substantially alter their operating window without also making them large and unwieldly. Such issues can lead to needing to retorque the bolted connections which is expensive and difficult to execute. Accordingly, providing improved stability to such joints is needed.

Thus, there remains a need for load distribution devices, such as connector devices described below, and methods of making thereof, that address the aforementioned issues.

Therefore, it is an object of the invention to provide connector devices that can reduce or eliminate the aforementioned issues.

It is also an object of the invention to provide for methods of making such connector devices.

### SUMMARY OF THE INVENTION

Described herein are coated connector devices and methods of making and using thereof are described herein. Elastic coating materials which can be applied to such connector devices can improve the operation at joints incorporating such devices.

In one non-limiting instance, a connector device, the connector device includes:
an elastic coating material on at least one surface portion of the connector device;
where the connector device can interface a first object and a second object and the elastic coating material is capable of contacting a surface of at least the first or the second object.

In some instances, the connector devices can be chosen, without limitation, from washers such as belleville washers, flat washers, spring washers, split lock washers, wave washers, fender washers, lock washers, internal tooth lock washers, external tooth lock washers, shoulder washers, countersunk washers, sealing washers, torque washers, tab washers, spherical washers, dome washers, cup washers, square washers, or dock washers. Other types of known connector devices can also be used. In some instances, the connector devices are usually made of metal, metal alloys, or combinations thereof. Exemplary metals and alloys include, but are not limited to copper, copper alloys, aluminum, aluminum alloys, titanium and stainless steel. The connector devices can have any suitable size and/or shape known suitable for their purpose and use. In some instances, the connector device includes at least one or more holes, such as like when it is a washer.

The first and second objects are not particularly restricted as long as the connector device can be placed in between the objects. In some instances, the first object is a fastener, such as a threaded fastener. In some cases, the first object is selected, without limitation, from a bolt, a nut, a clamp, a clip, or a rivet. In some cases, the threaded fastener is a bolt, a nut, or a screw, which can be made of a metal, such as copper, brass, bronze, aluminum, or steel. In some instances, the second object is a bus bar, which can be made of a metal, such as copper, brass, or aluminum. In some other instances, the second object is a flange or a plate, such as made of copper, brass, aluminum, steel, iron, poly(vinyl chloride) (PVC), acrylonitrile butadiene styrene (ABS), high-density polyethylene (HDPE), or high impact polystyrene (HIPS).

In some instances, the connector device may be under a torque load (i.e., rotational force) when interfacing the first object and the second objects. In some instances, the connector device may be under a normal load (i.e., clamping force) when interfacing the first object and the second objects. In some instances, the elastic coating material can absorb or dampen vibrations due to electromagnetic field oscillations or due to cyclical mechanical action, shocks, and/or resist thermal expansion of the first object and/or the second object to prevent or reduce a loss of the torque load over a period of time, and/or to prevent or reduce permanent deformation, creep, or stress relaxation of the first object and/or the second object from additional load on the joint over a period of time, as compared to a connector device that does not include any coating thereon.

In some instances, the elastic coating material is or includes an elastic polymer or elastomer. Non-limiting examples of elastic polymers or elastomers include rubbers, silicones, polyurethane, styrene-ethylene-butylene-styrene (SEBS), styrene-butadiene rubber (SBR), nitrile butadiene rubber (NBR), ethylene propylene diene monomer rubber (EPDM), polyisoprene, and combinations thereof.

In some instances, the elastic coating material is or includes a polymer composite, such as made from a combination of an elastomer and a reinforcing elastic material (such as nanotubes or fibers made of carbon, metals, or ceramics).

In some other instances, the elastic coating material is or includes a plurality of nanostructures therein. Such nanostructures can include, without limitation, aligned graphene, aligned carbon nanotubes, aligned carbon nanofibers, or other alignable materials (such as silica, boron nitride, copper, or silver nanowires).

In some other instances, the connector devices described herein include an elastic coating material thereon which is formed of carbon nanotube array(s) or sheet(s) on a (metal) substrate.

Methods for preparing such connector devices with elastic coating materials thereon are provided herein. In one non-limiting example, a method of forming the connector device, as described herein, includes the steps of:
(a) applying an elastic coating material onto at least one surface portion of a connector device;
   wherein the connector device can interface a first object and a second object and the coating is capable of contacting at least the first or the second object's surface.

The coated connector devices described can be used in various applications. In some instances, a device or component can include a connector device as described herein, where the device or component is optionally an electronic device or electronic component.

In some instances, the connector devices described herein form part of a joint. In one non-limiting instance, a joint includes:
a first object; and
a second object;
wherein a connector device, as described herein, interfaces the first object and the second object.

In some instances, the joint is under a torque load (i.e., rotational force). In some instances, the joint is under a normal load (i.e., clamping force). A normal load is the typical load that the coated connector experiences, whereas the fastener (i.e., bolt) experiences the torque load. In some instances, the elastic coating material can absorb or dampen vibrations due to electromagnetic field oscillations or due to cyclical mechanical action, shocks, and/or resist thermal expansion of the first object and/or the second object to prevent or reduce a loss of the torque load over a period of time, and/or to prevent or reduce permanent deformation, creep, or stress relaxation of the first object and/or the second object from additional load on the joint over a period of time, as compared to a joint with a connector device that does not include any coating thereon. In some instances, the elastic coating material reduces, eliminates, or relaxes stresses at the interface between the first and the second objects, as compared to a joint with a connector device that does not include any coating thereon.

Such joints can be formed by various methods. In one non-limiting instance, a method of forming a joint includes the steps of:
(a′) placing a coated connector device, as described herein, in between a first object and a second object;
wherein the connector device interfaces the first object and the second object.

In some instances, the method above further includes a step of applying a torque load to the joint through the first object. In some instances, the torque load applied is in a range of about 1 to 500 in-lb, 5 to 50 in-lb, 50 to 100 in-lb 100 to 500 in-lb or 500 to 1,000 in-lb, as well as individual values or sub-ranges contained within the aforementioned ranges.

In some instances, the method above further includes a step of applying a normal load or clamping load to the joint through the first object. In some instances, the normal load or clamping load applied is in a range of about 0.1 to 1 kN, 0.1 to 2.5 kN, 0.1 to 5 kN, 0.1 to 7.5 kN, 0.1 to 10 kN, 0.1 to 12.5 kN, 0.1 to 15 kN, 0.1 to 17.5 kN, 0.1 to 20 kN, 0.1 to 22.5 kN, 0.1 to 25 kN, 0.1 to 27.5 kN, 0.1 to 30 kN, 0.1 to 32.5 kN, or 0.1 to 35 kN, as well as individual values or sub-ranges contained within the aforementioned ranges.

In some instances, the joints described herein can be broken or taken apart as needed. In one non-limiting case, a method of breaking a joint, where the joint includes:
a first object; and
a second object;
wherein the connector device, as described herein, interfaces the first object and the second object; the method includes the step of:
(a″) separating the connector device, the first object, and the second object.

In some instances, the above method further includes the step of removing any torque load which may be present on the connector device, the first object, and the second object prior to step (a″).

### BRIEF DESCRIPTION OF THE DRAWINGS

FIG. 1A shows a non-limiting illustration of a coated connector device 100 wherein connector device 110, such as a washer, has an elastic coating material 120 thereon.

FIG. 1B shows a non-limiting illustration of a coated connector device 100′ wherein connector device 110′, such as a washer, has an elastic coating material 120′ including multiple layers thereon which optionally include separations 125′ in between respective layers.

FIG. 2A shows a non-limiting illustration of a joint 200 including two connector devices 210, such as a washer, having elastic coating materials 220 thereon, a bolt 230, a nut 240, where the connector devices, bolt, and nut form the joint connecting bus bars 250.

FIG. 2B shows a non-limiting illustration of a joint 200′ including two connector devices 210a′ and 210′b, such as a washer, having elastic coating materials 220a′ and 220b′ thereon, a bolt 230′, a nut 240′, where the connector devices, bolt, and nut form the joint connecting bus bars 250′.

FIG. 3A shows a non-limiting illustration of a joint under lateral thermal expansion forces.

FIG. 3B shows a non-limiting illustration of an interface 300 of a joint, under lateral thermal expansion forces, where an elastic coating material including aligned nanotubes is present at the interface between a connector device and an object and the nanotubes can bend elastically to accommodate movement and in-plane shear forces while maintaining contact with the joint.

FIG. 4A shows a non-limiting partial illustration of a joint including a connector device 310, such as a fender washer, having an elastic coating material 320 thereon, a bolt 330, a nut 340, where the connector device, bolt, and nut form a joint connecting bus bars, such as 350.

FIG. 4B shows a non-limiting illustration of the interface between a bus bar and a washer, where an elastic coating material on the washer including aligned nanotubes is present at the interface and shows pre-load (left) and event load (right) conditions. The nanotubes can bend elastically to accommodate movement and load forces while maintaining contact with the joint.

FIG. 5A shows a theoretical analysis of a bus bar assembly including an elastic coating material at the washer-to-bar interface which can relieve stress concentrations that build up during thermal shock events (i.e. large expansion of the bars) and can dampen vibrations.

FIG. 5B shows a theoretical analysis of a bus bar assembly without any elastic coating material at the washer-to-bar interface.

FIG. 6A shows a non-limiting partial illustration of a joint including a connector device 310, such as a washer, having elastic coating materials 320 thereon, a bolt 330, where the connector device, bolt, and a nut (not shown) form a joint connecting bus bars, such as 350.

FIG. 6B shows heat dissipation simulations of bus bar bolted assemblies with (top) and without (bottom) an elastic coating material extending across the entire bus bar surface.

FIGS. 7A and 7B show graphs of retention (%) of an applied preload for up to 150 cycles (at 12 Hz per second) for a coated connector (washer) compared to the belleville+washer (without such a coating present), respectively.

FIGS. 7C and 7D, show graphs of retention (%) of an applied preload for up to 2000 cycles (at 12 Hz per second) for a coated connector (washer) compared to the belleville+washer (without such a coating present), respectively.

### DETAILED DESCRIPTION OF THE INVENTION

Coated connector devices and methods of making and using thereof are described herein.

### I. Definitions

“Compliant” or “Compliance,” as used herein, refers to the ability of a material to conform when contacted to one or more surfaces such that efficient conformance to the asperities of the adjoining surface results in sufficient or high contact areas at the interfaces between the surfaces and the material.

“Interdigitation” or “Interdigitating”, as used herein, refers to the ability and or degree which one or more individual nanostructure elements of an array or sheet to infiltrate or penetrate into the adjacent nanostructure elements of another array or sheet when the two different arrays or sheets are contacted or stacked.

“Carbon Nanotube Array” or “CNT array” or “CNT forest”, as used herein, refers to a plurality of carbon nanotubes which are vertically aligned on a surface of a material. Carbon nanotubes are said to be “vertically aligned” when they are substantially perpendicular to the surface on which they are supported or attached. Nanotubes are said to be substantially perpendicular when they are oriented on average within 30, 25, 20, 15, 10, or 5 degrees of the surface normal.

“Carbon Nanotube Sheet” or “CNT sheet”, as used herein, refers to a plurality of carbon nanotubes which are aligned in plane to create a freestanding sheet. Carbon nanotubes are said to be “aligned in plane” when they are substantially parallel to the surface of the sheet that they form. Nanotubes are said to be substantially parallel when they are oriented on average greater than 40, 50, 60, 70, 80, or 85 degrees from sheet surface normal.

“Coating material” as used herein, generally refers to polymers and/or molecules that can bond to CNTs through van der Waals bonds, π-π stacking, mechanical wrapping and/or covalent bonds and bond to metal, metal oxide, or semiconductor material surfaces through van der Waals bonds, π-π stacking, and/or covalent bonds.

“Deformable,” as used herein, refers to the ability of a material to change shape under the application of an external force. This typically refers to elastic deformation, where the deformation is temporary, such that when the external force is removed, the material returns to its original shape/dimensions.

“Elastic compression,” as used herein, refers to the temporary reduction in volume or length of a material when an external compressive force is applied.

“Elastic expansion,” as used herein, refers to the temporary increase in length, area, or volume of a material when an external tensile force or thermal energy is applied. When the force or heat is removed, the material returns to its original dimensions.

“Elastic recovery” or “elastic rebound,” as used herein, refers to the ability of a material to return to its original shape/dimension following compression, expansion, stretching, or other deformation.

“Compression set,” as used herein, refers to the permanent deformation of a material which remains when a force, such as compression, was applied to the material and the force was subsequently removed.

“Thermal expansion,” as used herein refers to the tendency of matter to change in volume in response to a change in temperature. Exemplary types of thermal expansion can include: (1) Linear Expansion, which refers to the change in one dimension (length) of an object; (2) Area Expansion, which refers to the change in area of a material; and (3) Volume Expansion, which refers to the change in volume of a material.

Numerical ranges disclosed in the present application include, but are not limited to, ranges of temperatures, ranges of pressures, ranges of molecular weights, ranges of integers, ranges of conductance and resistance values, ranges of times, and ranges of thicknesses. The disclosed ranges of any type, disclose individually each possible number that such a range could reasonably encompass, as well as any sub-ranges and combinations of sub-ranges encompassed therein. For example, disclosure of a pressure range is intended to disclose individually every possible pressure value that such a range could encompass, consistent with the disclosure herein.

Use of the term “about” is intended to describe values either above or below the stated value, which the term “about” modifies, in a range of approx. +/−10%; in other instances the values may range in value either above or below the stated value in a range of approx. +/−5%. When the term “about” is used before a range of numbers (i.e., about 1-5) or before a series of numbers (i.e., about 1, 2, 3, 4, etc.) it is intended to modify both ends of the range of numbers or each of the numbers in the series, unless specified otherwise.

### II. Coated Connector Devices

Various types of connector devices are known in the art and are commercially available. Such connector devices can be used as load distribution devices at joints. Such connector devices alone can, in some instances, be used to prevent load losses at joints, at very high loads these devices are typically well outside of their elastic range, and it is difficult to substantially alter their operating window without also making them large and unwieldly. Accordingly, described below are elastic coating materials which can be applied to such connector devices to improve the operation at joints incorporating such devices.

In one non-limiting instance, a connector device, the connector device includes:
an elastic coating material on at least one surface portion of the connector device;
where the connector device can interface a first object and a second object and the elastic coating material is capable of contacting a surface of at least the first or the second object.

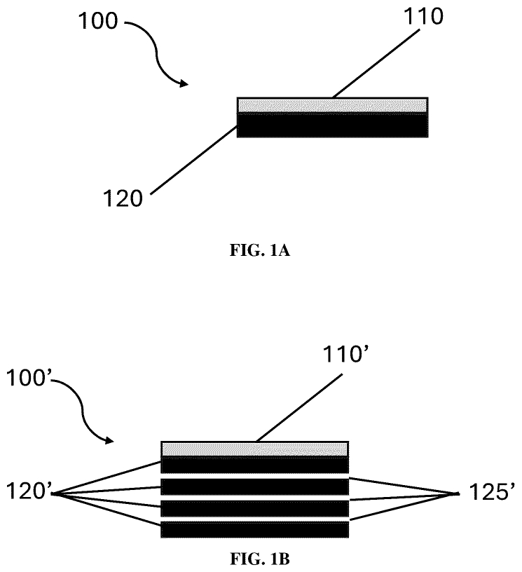

As shown in FIG. 1A, a non-limiting schematic of a coated connector device 100 wherein connector device 110, such as a washer, has an elastic coating material 120 thereon. As shown in FIG. 1B, a non-limiting schematic of a coated connector device 100′ wherein connector device 110′, such as a washer, has an elastic coating material 120′ including multiple layers thereon which optionally include separations 125′ in between respective layers. It is understood that for FIGS. 1A-1B only one side of the connector device is shown to have the coating thereon but that both sides may be coated.

In some instances, the connector devices can be chosen, without limitation, from washers such as belleville washers, flat washers, spring washers, split lock washers, wave washers, fender washers, lock washers, internal tooth lock washers, external tooth lock washers, shoulder washers, countersunk washers, sealing washers, torque washers, tab washers, spherical washers, dome washers, cup washers, square washers, or dock washers. Other types of known connector devices can also be used. In some instances, the connector devices are usually made of metal, metal alloys, or combinations thereof. Exemplary metals and alloys include, but are not limited to copper, copper alloys, aluminum, aluminum alloys, titanium and stainless steel. The connector devices can have any suitable size and/or shape known suitable for their purpose and use. In some instances, the connector device includes at least one or more holes, such as like when it is a washer.

The first and second objects are not particularly restricted as long as the connector device can be placed in between the objects. In some instances, the first object is a fastener, such as a threaded fastener. In some cases, the first object is selected, without limitation, from a bolt, a nut, a clamp, a clip, or a rivet. In some cases, the threaded fastener is a bolt, a nut, or a screw, which can be made of a metal, such as copper, brass, bronze, aluminum, or steel. In some instances, the second object is a bus bar, which can be made of a metal, such as copper, brass, or aluminum. In some other instances, the second object is a flange or a plate, such as made of copper, brass, aluminum, steel, iron, poly(vinyl chloride) (PVC), acrylonitrile butadiene styrene (ABS), high-density polyethylene (HDPE), or high impact polystyrene (HIPS).

In some instances, the elastic coating material has the form of a laminate, which has been applied onto the connector device. In some instances, the laminate is applied onto a least a surface portion of the connector device. In some instances, the connector devices may be coated completely or partially (i.e., 10%, 20%, 30%, 40%, 50%, 60%, 70%, 80%, 90%, or higher of the total surface area of the connector device) with one or more elastic coating materials, as described below.

The elastic coating material is deformable. In some instances, the elastic coating material can deform and elastically recover when placed under a load of about 10 to 100 psi, 100 to 30,000 psi, 5,000 to 30,000 psi or 100 to 5000 psi, as well as sub-ranges or individual values contained within the aforementioned ranges. In some instances, the elastic coating material has an elastic compression and elastic recovery/rebound to maintain a load, which is on the first and second object's surfaces, where the elastic compression can be a deformation of about 1 to 10 um or 1 to 100 um of the thickness of the elastic coating material, as well as sub-ranges or individual values contained within the aforementioned ranges. In some instances, the elastic coating material has an elastic shear deformation which can accommodate lateral strain(s) of the second object's surface without translating all of the shear load to the first object, where the transverse expansion and compression can be within a range of 1 to 100 um, 100 to 1000 or 1000 to 10000 um, as well as sub-ranges or individual values contained within the aforementioned ranges. In some instances, the elastic coating material has a friction coefficient which can accommodate lateral strain(s) of the second object's surface without translating all or substantially all of the shear load to the first object, where the friction coefficient can be within a range of about 0.05 to 0.1, 0.1 to 0.4, or 0.4 to 0.5, as well as sub-ranges or individual values contained within the aforementioned ranges. “Substantially all,” refers to translating less than about 5%, 4%, 3% 2%, 1%, 0.5% or 0.1% of the shear load to the first object.

In some instances, the elastic coating material is capable of filling the entirety or substantially the entirety of the interface (space) between the first and the second object. “Substantially,” refers to at least about 95%, 96%, 97%, 98%, 99%, 99.5%, 99.9% or more of the space is filled by the material. In other words, when placed between surfaces of the first and second objects the material occupies and fills the space where the coating interfaces the two objects. Such as when the interface, or surfaces of the first and/or second objects, includes non-planarities and/or curvatures thereon.

In some instances, the connector device may be under a torque load (i.e., rotational force) when interfacing the first object and the second objects. In some instances, the connector device may be under a normal load (i.e., clamping force) when interfacing the first object and the second objects. In some instances, the elastic coating material can absorb or dampen vibrations due to electromagnetic field oscillations or due to cyclical mechanical action, shocks, and/or resist thermal expansion of the first object and/or the second object to prevent or reduce a loss of the torque load over a period of time, and/or to prevent or reduce permanent deformation, creep, or stress relaxation of the first object and/or the second object from additional load on the joint over a period of time, as compared to a connector device that does not include any coating thereon. In some instances, the elastic coating material can eliminate or reduce the loss of torque load by at least about 0.1% to 99.9%, 1 to 5%, 5 to 10%, 10 to 25%, or 25 to 50% over the period of time, as well as individual values or sub-ranges contained within the aforementioned ranges. In some instances, the period of time is at least about 1, 2, 3, 4, 5, 6, 7, 8, 9, 10, 11, or 12 months, as well as individual values or sub-ranges contained within the aforementioned ranges. In some instances, the period of time is at least about 1 to 5 years, 1 to 4 years, 1 to 3 years, or 1 to 2 years, as well as individual values or sub-ranges contained within the aforementioned ranges.

In some instances, the elastic coating material of the connector device can reduce thermal expansion forces, such as movements and/or shear forces and/or axial forces, which occur at the interface between the first and the second objects, as compared to a connector device that does not include any coating thereon.

In some instances, the elastic coating material of the connector device can improve thermal transport at the interface between the first and the second objects, as compared to a connector device that does not include any coating thereon. In some instances, thermal transport is improved by at least about 0.1% to 99.9%, 1 to 5%, 5 to 10%, 10 to 25%, or 25 to 50%, as compared to use of a connector device that does not include any coating thereon, as well as individual values or sub-ranges contained within the aforementioned ranges.

In some instances, the elastic coating material can reduce, eliminate, or relax stresses at the interface between the first and the second objects, as compared to a connector device that does not include any coating thereon. In still other instances, the elastic coating material can reduce corrosion, such as galvanic corrosion, as compared to a connector device that does not include any coating thereon.

In some instances, the elastic coating materials described herein are flexible and conformable. The elastic coating materials can be manufactured to have any shape and size suitable for covering a defined surface or portion thereof on a connector device. In some instances, the coatings form an O-ring shape suitable to cover hole(s) of a connector device, such as a washer, but any shape can be made to suit other known types of connector devices. In some instances, laminates, sheets, tapes, or rolls of the coating are manufactured and the desired shape of the coating can be cut out or punched out of the sheets, tapes, or rolls. In some instances, the elastic coating material has a thickness in the range of between about 25 to 10,000 microns, between about 25 to 1000 microns, between about 25 to 750 microns, between about 25 to 500 microns, between about 25 to 250 microns, between about 25 to 100 microns, or between about 25 to 50 microns, as well as individual values or sub-ranges contained within the aforementioned ranges. In some instances, the elastic coating material has a thickness in the range of between about 10 to 100 microns, 100 to 500 microns, 500 to 1000 microns, or 5000 to 10,000 microns, as well as individual values or sub-ranges contained within the aforementioned ranges. The elastic coating materials may themselves be adhesive. In some other instances, if the coatings are not adhesive they may further include one or more additional layers, such as an adhesive layer thereon. The adhesive may be selected from a hot glue or a hot melt adhesive that combines wax, tackifiers and a polymer base to provide improved adhesion properties to one or more surfaces. In some instances, the adhesive is a pressure sensitive adhesive. In certain other instances, the adhesive is a monomer that polymerizes upon contact with air or water, such as a cyanoacrylate. In yet other instances, the adhesive is a combination of a pressure sensitive adhesive and a thermally activated (or activatable) adhesive polymers which enhances ease of adhesion of the coatings to a surface(s), by way of the pressure sensitive adhesive and additional and more permanent or semi-permanent adhesion by way of the thermal adhesive. In some instances, the adhesive is an epoxy adhesive. Adhesive coatings described herein of any form can also be removable (such as by peeling). When necessary or desired, the coatings can be removed from the connector device (requiring little to no scraping for removal and leaving little to no residue or debris when the coating is peeled off the connector). Ease of removal of the coatings is beneficial for replacing an old or worn-out coating with a new coating. In some instances, when a connector device is to be recycled it is advantageous to be able to remove the coating prior to recycling the metal of the connector device.

The elastic coating materials described are optionally reformable. A reformable coating can be heated and reformed into a new shape to conform to a surface(s), such as the hole(s) or surface topographies, of a connector device, A reformable coating can be customized to any desired shape.

In some instances, the elastic coating material includes an adhesive which can prevent or reduce a loss of the torque load over time, as compared to a connector device that does not include any adhesive.

In some instances, the elastic coating material is or includes an elastic polymer or elastomer. Non-limiting examples of elastic polymers or elastomers include rubbers, silicones, polyurethane, styrene-ethylene-butylene-styrene (SEBS), styrene-butadiene rubber (SBR), nitrile butadiene rubber (NBR), ethylene propylene diene monomer rubber (EPDM), polyisoprene, and combinations thereof.

In some instances, the elastic coating material is or includes a polymer composite, such as made from a combination of an elastomer and a reinforcing elastic material (such as nanotubes or fibers made of carbon, metals, or ceramics).

In some other instances, the elastic coating material is or includes a plurality of nanostructures therein. Such nanostructures can include, without limitation, aligned graphene, aligned carbon nanotubes, aligned carbon nanofibers, and/or other alignable materials (such as silica, boron nitride, copper, or silver nanowires). Aligned typically refers to vertically aligned therein when the nanostructures are perpendicular or substantially perpendicular in one direction. Such nanostructures are said to be substantially perpendicular when they are oriented on average within 30, 25, 20, 15, 10, or 5 degrees of the surface normal.

In some other instances, the connector devices described herein include an elastic coating material thereon which is formed of carbon nanotube array(s) or sheet(s) on a (metal) substrate. The elastic coating material can be formed of a single tiered or single layered structure or a multitiered or multilayered structure formed from carbon nanotube arrays or sheets, as described in detail below. The elastic coating material is typically formed and then adhered or applied onto surface(s) of the connector device and is optionally removable (such as by peeling), when necessary, from the connector device (requiring little to no scraping for removal and leaving little to no residue or debris when the coating is peeled off the connector device).

### III. Elastic Coating Materials for Connector Devices Formed from Carbon Nanotube Arrays or Sheets

In some instances, the elastic coating materials for the connector devices described herein can be formed from carbon nanotube arrays or carbon nanotube sheets supported on, or attached to, the surface of an inert substrate/support, as described below.

### A. Carbon Nanotube Arrays

Carbon nanotube arrays contain a plurality of carbon nanotubes supported on, or attached to, the surface of an inert substrate/support, such as a metallic (e.g., Al or Au) foil, metal alloys (i.e., steel). In some instances, the substrate/support can be a flexible, electrically, and thermally conductive substrate, such as graphite or other carbon-based material. In yet other instances, the substrate/support can be an electrically insulating substrate such as a flexible ceramic. The CNT arrays can be formed using the methods described below. The CNTs are vertically aligned on the substrate/support. CNTs are said to be “vertically aligned” when they are substantially perpendicular to the surface on which they are supported or attached. Nanotubes are said to be substantially perpendicular when they are oriented on average within 30, 25, 20, 15, 10, or 5 degrees of the surface normal.

Generally, the nanotubes are present at a sufficient density such that the nanotubes are self-supporting and adopt a substantially perpendicular orientation to the surface of the multilayer substrate. In some cases, the nanotubes are spaced at optimal distances from one another and are of uniform height to minimize thermal transfer losses, thereby maximizing their collective thermal diffusivity.

The CNT arrays contain nanotubes which are continuous from the top of the array (i.e., the surface formed by the distal end of the carbon nanotubes when vertically aligned on the multilayer substrate) to bottom of the array (i.e., the surface of the multilayer substrate). The array may be formed from multi-wall carbon nanotubes (MWNTs), which generally refers to nanotubes having between approximately 4 and approximately 10 walls. The array may also be formed from few-wall nanotubes (FWNTs), which generally refer to nanotubes containing approximately 1-3 walls. FWNTs include single-wall carbon nanotubes (SWNTs), double-wall carbon nanotubes (DWNTS), and triple-wall carbon nanotubes (TWNTs). In certain instances, the nanotubes are MWNTs. In some instances, the diameter of MWNTs in the arrays ranges from 5 to 40 nm, 15 to 30 nm, or about 20 nm. The length of CNTs in the arrays can range from 1 to 5,000 micrometers, 5 to 5000 micrometers, 5 to 2500 micrometers, 5 to 2000 micrometers, or 5 to 1000 micrometers, as well as individual values or sub-ranges contained within the aforementioned ranges. In some instances, the length of CNTs in the arrays can range from about 1 to 500 micrometers or 1 to 100 micrometers, as well as individual values or sub-ranges contained within the aforementioned ranges.

The CNTs display strong adhesion to the multilayer substrate. In certain instances, the CNT array or sheet will remain substantially intact after being immersed in a solvent, such as ethanol, and sonicated for a period of at least five minutes. In particular instances, at least about 90%, 95%, 96%, 97%, 98%, 99%, or 99.9% of the CNTs remain on the surface after sonication in ethanol.

### B. Carbon Nanotube Sheets

Carbon nanotube sheets are also described herein. The sheets contain a plurality of carbon nanotubes that support each other through strong van der Waals force interactions and mechanical entanglement to form a freestanding material. The CNT sheets can be formed using the methods described below. The CNTs form a freestanding sheet and are aligned in plane with the surface of this sheet. CNTs are said to be “aligned in plane” when they are substantially parallel to the surface of the sheet that they form. Nanotubes are said to be substantially parallel when they are oriented on average greater than 40, 50, 60, 70, 80, or 85 degrees from sheet surface normal.

Generally, the nanotubes are present at a sufficient density such that the nanotubes are self-supporting and adopt a substantially parallel orientation to the surface of the sheet. In some cases, the nanotubes are spaced at optimal distances from one another and are of uniform length to minimize thermal transfer losses, thereby maximizing their collective thermal diffusivity.

The CNT sheets may be formed from multi-wall carbon nanotubes (MWNTs), which generally refers to nanotubes having between approximately 4 and approximately 10 walls. The sheets may also be formed from few-wall nanotubes (FWNTs), which generally refers to nanotubes containing approximately 1-3 walls. FWNTs include single-wall carbon nanotubes (SWNTs), double-wall carbon nanotubes (DWNTS), and triple-wall carbon nanotubes (TWNTs). In certain instances, the nanotubes are MWNTs. In some instances, the diameter of MWNTs in the arrays ranges from 5 to 40 nm, 15 to 30 nm, or is about 20 nm. The length of CNTs in the sheets can range from 1 to 5,000 micrometers, 100 to 5000 micrometers, 500 to 5000 micrometers, or 1000 to 5000 micrometers, as well as individual values or sub-ranges contained within the aforementioned ranges. In some instances, the length of CNTs in the sheets can range from 1-500 micrometers or 1 to 100 micrometers, as well as individual values or sub-ranges contained within the aforementioned ranges.

### C. Carbon Nanotube Coating Materials

The CNT array or sheet can include a coating material which adhere or are bonded to the CNTs. The coating/coating material can be applied as described below. In some instances, the coating contains one or more oligomeric materials, polymeric materials, waxes, or combinations thereof. In other instances, the coating contains one or more non-polymeric materials. In some instances, the coating can contain a mixture of oligomeric, waxes, and/or polymeric material and non-polymeric materials. In some instances, the coating material is or includes an elastic polymer and/or elastomer. The elastic polymer and/or elastomer can be selected, without limitation, from as rubbers, silicones, polyurethane, styrene-ethylene-butylene-styrene (SEBS), styrene-butadiene rubber (SBR), nitrile butadiene rubber (NBR), ethylene propylene diene monomer rubber (EPDM), polyisoprene, or combinations thereof.

In certain instances, the coating material(s) act as a bonding agent(s) which can bonded, such as chemically, the carbon nanotubes of the stacked arrays or sheets. Without limitation, such coating material(s) which can act as bonding agents(s) can be selected from adhesives (i.e., acrylate adhesives) and a phase change material (i.e., a wax or waxes).

In some instances, the coating which adheres or is bonded to the CNTs of an array is applied before two or more CNT arrays or sheets are stacked while in other instances, the coating which adheres or is bonded to the CNTs of an array is applied following stacking of two or more CNT arrays or sheets. In yet other instances, the coating is infiltrated or backfilled into multilayered or multitiered structures formed of stacked CNT arrays or sheets and adheres or is bonded to the CNTs of the arrays forming the structure. As used herein, “infiltration” or “infiltrated” refer to a coating material(s) which are permeated through at least some of the carbon nanotubes of the arrays or sheets which were stacked to form the multilayered or multitiered structures. In some instances, the extent of infiltration is in the range of 0.1-99.9%. In some instances, the infiltrated coating material at least partially fills the interstitial space between carbon nanotubes while in some other instances the infiltrated coating coats at least some of the surfaces of the carbon nanotubes, or both. In some instances, the infiltrated coating material fills all or substantially all (i.e., at least about 95%, 96%, 97%, 98%, or 99%) of the interstitial space between carbon nanotubes present in the tiers or layers of the structure formed by stacking of the CNT arrays or sheets.

A variety of materials can be coated onto the CNT arrays or sheets, prior to stacking, during stacking, or following stacking. The coatings can be applied conformally to coat the tips and/or sidewalls of the CNTs. It is also desirable that the coating be reflowable as the interface is assembled using, for example, solvent, heat or some other easy to apply source. Polymers used as coatings must be thermally stable up to at least 130° C. In some instances, the coating is removable, such as by heat or dissolution in a solvent, to allow for “reworking” of the interface. “Reworking” or “reworkable,” as used herein, refers to breaking the interface (i.e., removing the coating) by applying solvent or heat.

### 1. Polymeric Carbon Nanotube Coating Materials

In some instances, the coating is, or contains, one or more polymeric materials. The polymer coating can contain a conjugated polymer, such as an aromatic, heteroaromatic, or non-aromatic polymer, or a non-conjugated polymer.

Suitable classes of conjugated polymers include polyaromatic and polyheteroaromatics including, but not limited to, polythiophenes (including alkyl-substituted polythiophenes), polystyrenes, polypyrroles, polyacetylenes, polyanilines, polyfluorenes, polyphenylenes, polypyrenes, polyazulenes, polynaphthalenes, polycarbazoles, polyindoles, polyazepines, poly(3,4-ethylenedioxythiophenes), poly(p-phenyl sulfides), and poly(p-phenylene vinylene). Suitable non-aromatic, conjugated polymers include, but are not limited to, polyacetylenes and polydiacetylenes. The polymer classes listed above include substituted polymers, wherein the polymer backbone is substituted with one or more functional groups, such as alkyl groups. In some instances, the polymer is polystyrene (PS). In other instances, the polymer is poly(3-hexythiophene) (P3HT). In other instances, the polymer is poly(3,4-3thylenedioxythiophene) (PEDOT) or poly(3,4-3thylenedioxythiophene) poly(styrenesulfonate) (PEDOT:PSS).

In other instances, the polymer is a non-conjugated polymer. Suitable non-conjugated include, but are not limited to, polyvinyl alcohols (PVA), poly(methyl methacrylates) (PMMA), polydimethylsiloxanes (PDMS), polyurethane, silicones, acrylics, and combinations (blends) thereof.

In other instances, the polymer is a paraffin wax. In other instances, the polymer is a synthetic wax such as Fischer-Tropsch waxes or polyethylene waxes. In other instances, the polymer is a wax that has a melting temperature above 80, 90, 100, 110, 120° C., or above 130° C.

In other instances, the polymer is an adhesive, such as, but not limited to, a hot glue or hot melt adhesive that combines wax, tackifiers and a polymer base to provide improved adhesion properties to one or more surfaces. In some instances, the adhesive is a pressure sensitive adhesive.

In certain other instances, the adhesive is a monomer that polymerizes upon contact with air or water such as a cyanoacrylate. In yet other instances, the adhesive is a combination of a pressure sensitive adhesive and a thermally activated (or activatable) adhesive polymers which enhances ease of adhesion of a multilayered or multitiered structure described herein which includes such a combination of coatings to a surface(s), by way of the pressure sensitive adhesive and additional and more permanent or semi-permanent adhesion by way of the thermal adhesive.

### D. Other Coating Materials

### 1. Metallic Nanoparticles

The CNT arrays or sheets can additionally be coated with one or more metal nanoparticles. One or more metal nanoparticles may be adsorbed to the distal ends and/or sidewalls of the CNTs to bond the distal ends and/or sidewalls of the CNTs to a surface, reduce thermal resistance between the CNT array or sheet and a surface, or combinations thereof. Metal nanoparticles can be applied to CNT arrays or sheets using a variety of methods known in the art.

Examples of suitable metal nanoparticles include palladium, gold, silver, titanium, iron, nickel, copper, and combinations thereof.

### 2. Flowable or Phase Change Materials

In certain instances, flowable or phase change materials are applied to the CNT arrays or sheets prior to stacking, during stacking, or following stacking. Flowable or phase change materials may be added to the CNT array or sheet to displace the air between CNTs and improve contact between the distal ends and/or sidewalls of CNTs and a surface, and as a result reduce thermal resistance of the array or sheet and the contact between the array or sheet and a surface, or combinations thereof. Flowable or phase change materials can be applied to CNT arrays using a variety of methods known in the art.

Examples of suitable flowable or phase change materials include paraffin waxes, polyethylene waxes, hydrocarbon-based waxes in general, and blends thereof. Other examples of suitable flowable or phase change materials that are neither wax nor polymeric include liquid metals, oils, organic-inorganic and inorganic-inorganic eutectics, and blends thereof. In some instances, the coating material, such as a non-polymeric coating material and the flowable or phase change material are the same material or materials.

### E. Multilayered or Multitiered Carbon Nanotube Structure-Based Coatings

The coatings may also be formed from the CNT arrays or sheets described above which are stacked according to the methods described below to afford multilayered or multitiered structures. A layer or tier is formed by contacting/stacking the carbon nanotubes of two CNT arrays or sheets, which interdigitate at least partially, and which may optionally be coated with a suitable coating material as described herein.

In some instances, the multilayered or multitiered structures can further include a coating, a coating of metallic nanoparticles, and/or a coating of flowable or phase change materials on the nanostructure elements, such as CNTs, of the arrays.

At least two CNT arrays or sheets can be stacked to form the multilayered or multitiered structures. By using more CNT arrays the thickness of the multilayered or multitiered structures can be increased as needed. In some instances, up to 5, 10, 15, 20, 25, 30, or more CNT arrays or sheets can be stacked according to the method described above. The thickness of the resulting multilayered or multitiered structures formed by stacking can be in the range 1-10,000 microns or more. In some instances, the thickness of the resulting multilayered or multitiered structures formed by stacking can be 1-3,000 micrometers or 70-3,000 micrometers. In some instances, the number of layers and/or thickness is based on the thickness of the CNT forest formed on the arrays used in the stacking process.

In a non-limiting instance, at least two vertically aligned arrays or sheets formed on supports/substrates are stacked/contacted such that the nanostructure elements, such as CNTs, of the arrays at least partially interdigitate on contact. In one instance, full interdigitation of nanostructure elements of the arrays occurs within one another when stacked. In other instances the arrays may interdigitate only at the tips of the nanostructure elements, such as CNTs. In yet other instances, the individual nanostructures can navigate through the nanostructures of the adjacent array during the interdigitating process and the nanostructure elements of the individual arrays, such as the CNTs or some portion thereof, fully or substantially interdigitate within one another; “substantially,” as used herein, refers to at least 95%, 96%, 97%, 98%, or 99% interdigitation between the nanostructure elements of the individual arrays. In some instances, the extent of interdigitation is in the range of about 0.1% to 99% or at least about 1%, 5%, 10%, 20%, 30%, 40%, 50%, 60%, 70%, 80%, 90%, or 95%.

In some instances the nanostructures of the stacked arrays, which interdigitate at least partially, may also form into larger superstructures, such as, but not limited to, tube bundles, clumps, or rows. These superstructures may be formed through mechanisms such as capillary clumping or by way of application of a polymer coating prior to, during, or following the stacking process.

In some instances, a polymer coating and/or adhesive, or other coating as described above, is applied to the CNT array(s) which are subsequently stacked. In such instances, the thickness of the coating and/or adhesive, or other coating as described above, is about 1 to 1000 nm, 1 to 500 nm, or 1 to 100 nm, as well as individual values or sub-ranges contained within the aforementioned ranges.

In addition to the above, the favorable deformation mechanics of CNTs present in the multilayered or multitiered structures allow them to efficiently conform to the asperities of adjoining surfaces, resulting in high contact areas at the interfaces.

### IV. Methods for Preparing Coated Connector Devices

Methods of preparing connector devices with elastic coating materials thereon are provided herein.

In one non-limiting example, a method of forming the connector device, as described herein, includes the steps of:
(a) applying an elastic coating material onto at least one surface portion of a connector device;
   wherein the connector device can interface a first object and a second object and the coating is capable of contacting at least the first or the second object's surface.

In some instances, the elastic coating material comprises an elastic polymer or elastomer, such as selected from such as rubbers, silicones, polyurethane, styrene-ethylene-butylene-styrene (SEBS), styrene-butadiene rubber (SBR), nitrile butadiene rubber (NBR), ethylene propylene diene monomer rubber (EPDM), polyisoprene, or combinations thereof.

In some instances, the elastic coating material comprises a polymer composite, such as made from a combination of an elastomer and a reinforcing elastic material (such as nanotubes or fibers made of carbon, metals, or ceramics).

In some instances, the elastic coating material includes nanostructures, such as carbon nanostructures like aligned graphene, aligned carbon nanotubes, aligned carbon nanofibers, and/or other alignable materials (such as silica, boron nitride, copper, or silver nanowires).

In some instances, the elastic coating material comprises at least a first layer or tier comprising a carbon nanotube array or sheet. In some instances, the carbon nanotube array or sheet is on a metal substrate.

In some instances, the carbon nanotube array or sheet includes a coating material on at least some of the interstitial space between the carbon nanotubes of the carbon nanotube array or sheet. In some instances, a coating material encapsulates the carbon nanotubes of the carbon nanotube array or sheet; and the coating material is optionally an elastic polymer or elastomer. In some instances, the elastic coating material comprises at least a second layer or tier comprising a carbon nanotube array or sheet, where the carbon nanotubes of the array or sheet of the first layer or tier at least partially interdigitate the carbon nanotubes of the array or sheet of the second layer or tier to form a multilayered or multitiered structure. In some instances, the multilayered or multitiered structure includes three, four, or five additional layers or tiers as part of the multilayered or multitiered structure. More layers or tiers arc possible, such as six, seven, eight or more.

In some instances, the elastic coating material is applied to the connector device in the form of a laminate. In some instances, the elastic coating material is applied with an adhesive which is optionally a pressure sensitive adhesive, a thermally activatable adhesive, or a combination thereof.

In some instances, the connector device is a washer. In some instances, the washer is selected from the group consisting of belleville washers, spring washers, lock washers, fender washers, flat washers, split lock washers, wave washers, internal tooth lock washers, external tooth lock washers, shoulder washers, countersunk washers, sealing washers, torque washers, tab washers, spherical washers, dome washers, cup washers, square washers, and dock washers.

In some instances, the first object is a fastener, such as a bolt, a nut, a clamp, a clip, or a rivet. In some instances, the second object is a bus bar, such as made of copper, brass, or aluminum; or wherein the second object is a flange or plate, such as made of copper, brass, aluminum, steel, iron, poly(vinyl chloride) (PVC), acrylonitrile butadiene styrene (ABS), high-density polyethylene (HDPE), or high impact polystyrene (HIPS).

Methods of forming single and multilayered CNT-based structures is described below.

### A. Single Tiered or Single Layered Coatings

As previously noted, in some instances, the elastic coating material may include carbon nanotube arrays or sheets, in either single or multi-tiered structures, which can be produced as described below.

### 1. Carbon Nanotube Arrays

Carbon nanotube arrays can be prepared using techniques well known in the art. In one instance, the arrays are prepared as described in U.S. Publication No. 2014-0015158-A1, incorporated herein by reference. This method involves the use of multilayer substrates to promote the growth of dense vertically aligned CNT arrays and provide excellent adhesion between the CNTs and metal surfaces.

The multilayer substrates contain three or more layers deposited on an inert support, such as a metal surface. Generally, the multilayer substrate contains an adhesion layer, an interface layer, and a catalytic layer, deposited on the surface of an inert support. Generally, the support is formed at least in part from a metal, such as aluminum, platinum, gold, nickel, iron, tin, lead, silver, titanium, indium, copper, or combinations thereof. In certain instances, the support is a metallic foil, such as aluminum or copper foil. The support may also be a surface of a device, such as a conventional heat sink or heat spreader used in heat exchange applications.

The adhesion layer is formed of a material that improves the adhesion of the interface layer to the support. In certain instances, the adhesion layer is a thin film of iron. Generally, the adhesion layer must be thick enough to remain a continuous film at the elevated temperatures used to form CNTs. The adhesion layer also generally provides resistance to oxide and carbide formation during CNT synthesis at elevated temperatures.

The interface layer is typically formed from a metal which is oxidized under conditions of nanotube synthesis or during exposure to air after nanotube synthesis to form a suitable metal oxide. Examples of suitable materials include aluminum. Alternatively, the interface layer may be formed from a metal oxide, such as aluminum oxide or silicon oxide. Generally, the interface layer is thin enough to allow the catalytic layer and the adhesion layer to diffuse across it. In some instances, where the catalytic layer and the adhesion layer have the same composition, this reduces migration of the catalyst into the interface layer, improving the lifetime of the catalyst during nanotube growth.

The catalytic layer is typically a thin film formed from a transition metal that can catalyze the formation of carbon nanotubes via chemical vapor deposition. Examples of suitable materials that can be used to form the catalytic layer include iron, nickel, cobalt, rhodium, palladium, and combinations thereof. In some instances, the catalytic layer is formed of iron. The catalytic layer is of appropriate thickness to form catalytic nanoparticles or aggregates under the annealing conditions used during nanotube formation.

In other instances, the multilayer substrate serves as catalytic surface for the growth of a CNT array. In these instances, the process of CNT growth using chemical vapor deposition alters the morphology of the multilayer substrate. Specifically, upon heating, the interface layer is converted to a metal oxide, and forms a layer or partial layer of metal oxide nanoparticles or aggregates deposited on the adhesion layer. The catalytic layer similarly forms a series of catalytic nanoparticles or aggregates deposited on the metal oxide nanoparticles or aggregates. During CNT growth, CNTs form from the catalytic nanoparticles or aggregates. The resulting CNT arrays contain CNTs anchored to an inert support via an adhesion layer, metal oxide nanoparticles or aggregates, and/or catalytic nanoparticles or aggregates.

In particular instances, the multilayer substrate is formed from an iron adhesion layer of about 30 nm in thickness, an aluminum or alumina interface layer of about 10 nm in thickness, and an iron catalytic layer of about 3 nm in thickness deposited on a metal surface. In this instance, the iron adhesion layer adheres to both the metal surface and the Al (alumina nanoparticles or aggregates after growth) or Al₂O₃ interface layer. The iron catalytic layer forms iron nanoparticles or aggregates from which CNTs grow. These iron nanoparticles or aggregates are also bound to the alumina below.

As a result, well bonded interfaces exist on both sides of the oxide interface materials. Of metal/metal oxide interfaces, the iron-alumina interface is known to be one of the strongest in terms of bonding and chemical interaction. Further, metals (e.g., the iron adhesion layer and the metal surface) tend to bond well to each other because of strong electronic coupling. As a consequence, the CNTs are strongly anchored to the metal surface.

Further, subsurface diffusion of iron from the catalytic layer during nanotube growth is reduced because the same metal is on both sides of the oxide support, which balances the concentration gradients that would normally drive diffusion. Therefore, catalyst is not depleted during growth, improving the growth rate, density, and yield of nanotubes in the array.

In some instances, the CNT array is formed by vertically aligning a plurality of CNTs on the multilayer substrate described above. This can be accomplished, for example, by transferring an array of CNTs to the distal ends of CNTs grown on the multilayer substrate. In some instances, tall CNT arrays are transferred to the distal ends of very short CNTs on the multilayer substrate. This technique improves the bond strength by increasing the surface area for bonding.

The inert support for the CNT array or sheet can be a piece of metal foil, such as aluminum foil. In these cases, CNTs are anchored to a surface of the metal foil via an adhesion layer, metal oxide nanoparticles or aggregates, and catalytic nanoparticles or aggregates. In some instances only one surface (i.e., side) of the metal foil contains an array or sheet of aligned CNTs anchored to the surface. In other cases, both surfaces (i.e., sides) of the metal foil contain an array or sheet of aligned CNTs anchored to the surface. In other instances, the inert support for the CNT array or sheet is a surface of a conventional metal heat sink or heat spreader. In these cases, CNTs are anchored to a surface of the heat sink or heat spreader via an adhesion layer, metal oxide nanoparticles or aggregates, and catalytic nanoparticles or aggregates. This functionalized heat sink or heat spreader may then be abutted or adhered to a heat source, such as an integrated circuit package.

### 2. Carbon Nanotube Sheets

Carbon nanotube sheets can be prepared using techniques well known in the art. In one instance, the sheets are prepared as described in U.S. 7,993,620 B2. In this instance, CNT agglomerates are collected into sheets in-situ inside the growth chamber on metal foil substrates. The sheets can then be densified by removing the solvent. In another instance, the CNT sheets are made by vacuum filtration of CNT agglomerates that are dispersed in a solvent.

### 3. Coated Nanotube Arrays and Sheets

a. Carbon Nanotube Polymer Coatings

Polymers to be coated can be dissolved in one or more solvents and spray or dip coated or chemically or electrochemically deposited onto the vertical CNT forests or arrays grown on a substrate, or on a sheet, as described above. The coating materials can also be spray coated in powder form onto the top of vertical CNT forests or arrays grown on a substrate, or on CNT sheets as described above. The coatings includes polymers or molecules that bond to CNTs through van der Waals bonds, π-π stacking, mechanical wrapping and/or covalent bonds and bond to metal, metal oxide, or semiconductor material surfaces through van der Waals bonds, π-π stacking, and/or covalent bonds.

For spray or dip coating, coating solutions can be prepared by sonicating or stirring the coating materials for a suitable amount of time in an appropriate solvent. The solvent is typically an organic solvent or solvent and should be a solvent that is easily removed, for example by evaporation at room temperature or elevated temperature. Suitable solvents include, but are not limited to, chloroform, xylenes, hexanes, pyridine, tetrahydrofuran, ethyl acetate, and combinations thereof. The polymer can also be spray coated in dry form using powders with micron scale particle sizes, i.e., particles with diameters less than about 100, 50, 40, 20, 10 micrometers. In this instance, the polymer powder would need to be soaked with solvent or heated into a liquid melt to spread the powder particles into a more continuous coating after they are spray deposited.

The thickness of the polymer coatings is generally between 1 and 1000 nm, between 1 and 500 nm, between 1 and 100 nm, or between 1 and 50 nm. In some instances, the coating thickness is less than 500, 450, 400, 350, 300, 250, 200, 150, 100, 90, 80, 70, 60, 50, 40, 30, 20 or 10 nm.

Spray coating process restricts the deposition of coating to the CNT tips and limits clumping due to capillary forces associated with the drying of the solvent. The amount of coating visible on the CNT arrays increases with the number of sprays. Alternative techniques can be used to spray coat the coating materials onto the CNT arrays including techniques more suitable for coating on a commercial scale.

In another instance that demonstrates a coating process, CNT sheets are dipped into coating solutions or melted coatings to coat CNTs throughout the thickness of the sheets, increasing the thermal conductivity of the sheet in the cross-plane direction by greater than 20, 30, 40, 50, 60, or 70%.

In other instances, the coating material can be deposited on the CNT array or sheet using deposition techniques known in the art, such as chemical deposition (e.g., chemical vapor deposition (CVD)), aerosol spray deposition, and electrochemical deposition.

In one instance, a polymer coating can be applied by electrochemical deposition. In electrochemical deposition, the monomer of the polymer is dissolved in electrolyte and the CNT array or sheet is used as the working electrode, which is opposite the counter electrode. A potential is applied between the working and counter electrode with respect to a third reference electrode. The monomer is electrooxidized on the CNT array tips or sheet sidewalls that face the electrolyte as a result of the applied potential. Controlling the total time in which the potential is applied controls the thickness of the deposited polymer layer.

In some instances, the coating material is, or contains, one or more oligomeric and/or polymeric materials. In particular instances, the polymer can be a conjugated polymer, including aromatic and non-aromatic conjugated polymers. Suitable classes of conjugated polymers include polyaromatic and polyheteroaromatics including, but not limited to, polythiophenes (including alkyl-substituted polythiophenes), polystyrenes, polypyrroles, polyacetylenes, polyanilines, polyfluorenes, polyphenylenes, polypyrenes, polyazulenes, polynaphthalenes, polycarbazoles, polyindoles, polyazepines, poly(3,4-ethylenedioxythiophenes), poly(p-phenyl sulfides), and poly(p-phenylene vinylene). Suitable non-aromatic polymers include, but are not limited to, polyacetylenes and polydiacetylenes. The polymer classes listed above include substituted polymers, wherein the polymer backbone is substituted with one or more functional groups, such as alkyl groups. In some instances, the polymer is polystyrene (PS). In other instances, the polymer is poly(3-hexythiophene) (P3HT).

In other instances, the polymer is a non-conjugated polymer. Suitable non-conjugated include, but are not limited to, polyvinyl alcohols (PVA), poly(methyl methacrylates) (PMMA), polysiloxanes, polyurethanes, polydimethylsiloxanes (PDMS), and combinations (blends) thereof.

In other instances, the polymer is a paraffin wax. In other instances, the polymer is a synthetic wax such as Fischer-Tropsch waxes or polyethylene waxes. In other instances, the polymer is a wax that has a melting temperature above 80, 90, 100, 110, 120° C., or above 130° C.

In some other instances, the polymer is an adhesive, such as, but not limited to, a hot glue or hot melt adhesive that combines wax, tackifiers and a polymer base to provide improved surface adhesion. In some instances, the adhesive is a pressure sensitive adhesive. In certain other instances the adhesive is a monomer that polymerizes upon contact with air or water such as a cyanoacrylate. In yet other instances, the adhesive is a combination of a pressure sensitive adhesive polymer and a thermally activated (or activatable) adhesive polymer which enhances ease of adhesion of a multilayered or multitiered structure described herein which includes such a combination of coatings to a surface(s), by way of the pressure sensitive adhesive and additional and more permanent or semi-permanent adhesion by way of the thermal adhesive.

b. Metallic Nanoparticles

The CNT arrays or sheets can be coated with one or more metal nanoparticles. One or more metal nanoparticles may be adsorbed to the distal ends and/or sidewalls of the CNTs to bond the distal ends of the CNTs to a surface. Metal nanoparticles can be applied to CNT arrays or sheets using a variety of methods known in the art. For example, a solution of metal thiolate such as palladium hexadecanethiolate can be sprayed or spin coated onto the distal ends and/or sidewalls of the CNTs, and the organics can be baked off to leave palladium nanoparticles. In another example, electron-beam or sputter deposition can be used to coat metal nanoparticles or connected “film-like” assemblies of nanoparticles onto the distal ends and/or sidewalls of the CNTs. The metallic particles can be coated simultaneously with the coating or before or after coating.

Examples of suitable metal nanoparticles include palladium, gold, silver, titanium, iron, nickel, copper, aluminum, and combinations thereof.

c. Flowable or Phase Change Materials

In certain instances, flowable or phase change materials can be applied to the CNT array or sheet. Flowable or phase change materials may be added to the CNT array or sheet to displace the air between CNTs and improve contact between the distal ends of CNTs and a surface. Flowable or phase change materials can be applied to CNT arrays or sheets using a variety of methods known in the art. For example, flowable or phase change materials in their liquid state can be wicked into a CNT array or sheet by placing the array or sheet in partial or full contact with the liquid.

Examples of suitable flowable or phase change materials include paraffin waxes, polyethylene waxes, hydrocarbon-based waxes in general, and blends thereof. Other examples of suitable flowable or phase change materials that are neither wax nor polymeric include liquid metals, oils, organic-inorganic and inorganic-inorganic eutectics, and blends thereof. In some instances, the coating material(s) and the flowable or phase change material are the same.

The coatings, metallic particles, and/or flow or phase change materials described above can be applied directly to the CNT arrays or sheets and the coated CNT arrays or sheets can subsequently be stacked to form multilayered or multitiered structures. In certain other instances, the coatings, metallic particles, and/or flow or phase change materials described above are applied during the stacking of two or more CNT arrays or sheets. In still other instances, the coatings, metallic particles, and/or flow or phase change materials described above are applied following the stacking of two or more CNT arrays or sheets. In non-limiting instances, multilayered or multitiered structure(s) are formed by first stacking two or more CNT arrays or sheets and then the at least partially interdigitated tiers of the formed structures are infiltrated with one or more coatings, metallic particles, and/or flow or phase change materials, or combinations thereof. The introduction of such coatings/materials into the at least partially interdigitated tiers of the multilayered or multitiered structure(s) prior to, during, or after stacking can be used to modify and/or enhance the electrical transport or electrical resistance properties of the multilayered or multitiered structures resulting from the stacking of the CNT arrays or sheets.

### B. Multilayered or Multitiered Carbon Nanotube Structure-Based Coatings

In some instances, described herein, multilayered or multitiered structures formed by stacking of CNT arrays or sheets described above and formed by a method including the steps of:
(1) providing at least two or more CNT arrays or sheets; and
(2) stacking the at least two CNT arrays or sheets
   wherein the stacking results in at least partial interdigitation of the nanostructures, CNTs, of the arrays or sheets. In some instances, the method of making the multilayered or multitiered structures further includes a step of applying or infiltrating a coating, a coating of metallic nanoparticles, and/or a coating of flowable or phase change materials, which are described above. In some instances, the step of applying or infiltrating a coating, a coating of metallic nanoparticles, and/or a coating of flowable or phase change materials occurs prior to stacking, alternatively during stacking, or alternatively after stacking. In yet other instances, the method includes applying pressure during the stacking step. The applied pressure may be in the range of about 1 to 100 psi, 1 to 50 psi, 1 to 30 psi, 1 to 20 psi, or about 1 to 15 psi, as well as individual values or sub-ranges contained within the aforementioned ranges. In some instances, the pressure is about 15 psi. Pressure may be applied continuously until the adjacent tiers are bonded, if a coating material(s) which can act as a bonding agent, such as an adhesive or phase change material, is used. Pressure may be applied for any suitable amount of time. In some instances, only a short time is used, such as less than 1 minute, if no bonding agent is used.

At least two CNT arrays or sheets can be stacked to form the multilayered or multitiered structures. By using more CNT arrays the thickness of the multilayered or multitiered structures can be increased as needed. In some instances, up to 5, 10, 15, 20, 25, 30, or more CNT arrays or sheets can be stacked according to the method described above. The thickness of the resulting multilayered or multitiered structures formed by stacking can be in the range 1-10,000 microns or more, as well as individual values or sub-ranges contained within the aforementioned ranges.

In certain instances, the multilayered or multitiered structures can be formed by stacking multiple tiers of CNT arrays in a stepped manner, off-set manner, and/or other non-uniform manner in order to be able to conform to complex surfaces.

In a non-limiting instance, at least two vertically aligned arrays or sheets formed on supports/substrates are stacked/contacted such that the nanostructure elements, such as CNTs, of the arrays at least partially interdigitate on contact. In one instance full interdigitation of nanostructure elements of the arrays occurs within one another when stacked. In other instances, the arrays may interdigitate only at the tips of the nanostructure elements, such as CNTs. In yet other instances, the individual nanostructures can navigate through the nanostructures of the adjacent array during the interdigitating process.

In some instances, the nanostructures of the stacked arrays, which interdigitate at least partially, may also form into larger superstructures, such as, but not limited to, tube bundles, clumps, or rows. These superstructures may be formed through mechanisms such as capillary clumping or by way of application of a polymer coating prior to, during, or following the stacking process.

In some instances, a polymer coating and/or adhesive, or other coating as described above, is applied to the CNT array(s) which are then stacked. In such instances, the thickness of the coating and/or adhesive, or other coating as described above, is about 1 to 1000 nm, 1 to 500 nm, or 1 to 100 nm, as well as individual values or sub-ranges contained within the aforementioned ranges.

In certain instances of the above method, following the stacking step the method further includes a step of applying an adhesive, such as but not limited to a hot glue or hot melt adhesive that combines wax, tackifiers, and a polymer base to the resulting stack to provide improved adhesion properties to one or more surfaces of the stacked/tiered CNT arrays forming the multilayered or multitiered structure. In some instances, the adhesive is a pressure sensitive adhesive. In yet other instances, the adhesive is a combination of a pressure sensitive adhesive polymer and a thermally activated (or activatable) adhesive polymer which enhances ease of adhesion of a multilayered or multitiered structure described herein which includes such a combination of coatings to a surface(s), by way of the pressure sensitive adhesive and additional and more permanent or semi-permanent adhesion by way of the thermal adhesive.

### C. CNT-Based Elastic Coating Materials

The elastic coating materials prepared according to the methods described above may be single tiered or single layered structure coatings or multitiered or multilayered structure coatings. The coatings may be adhesive as noted above. The coatings need not be adhesive but may include a further step of applying one or more additional layers thereon, such as an adhesive layer, as described above.

The elastic coating materials may be formed as laminates, sheets, tapes, rolls, of any shape or size suited for application to a connector device. In some instances, the coatings form an O-ring shape suitable to cover the hole(s) of a connector device, but any shape can be made to suit other known types of connector devices. In some instances, laminates, sheets, tapes, or rolls of the coating are manufactured and the desired shape of the coating can be cut out or punched out of the sheets, tapes, or rolls.

The coating can have any suitable thickness. In some instances, the coating thickness is in the range of between about 25 to 2000 microns, between about 25 to 1000 microns, between about 25 to 750 microns, between about 25 to 500 microns, between about 25 to 250 microns, between about 25 to 100 microns, or between about 25 to 50 microns. In some instances, the elastic coating material has a thickness in a range of between about 25 to 10,000 microns, 10 to 100 microns, 100 to 500 microns, 500 to 1000 microns, or 5000 to 10,000 microns. Individual values or sub-ranges of any of the aforementioned ranges are possible.

### V. Coated Connector Device Applications

The coated connector devices described herein can be used for various applications, such as in forming joints which require stability. In particular, the connector devices having an elastic coating material thereon can allow for expansion and contraction of the joint when, for example, under a torque load or a normal load and the joint is exposed to thermal cycling which causes one or more thermal expansion(s) thereof.

Accordingly, in some instances, the connector devices described herein form part of a joint. In one non-limiting instance, a joint includes:
a first object; and
a second object;
wherein a connector device, as described herein, interfaces the first object and the second object.

In some instances, the interfaces of the joint are bolted electrical interfaces.

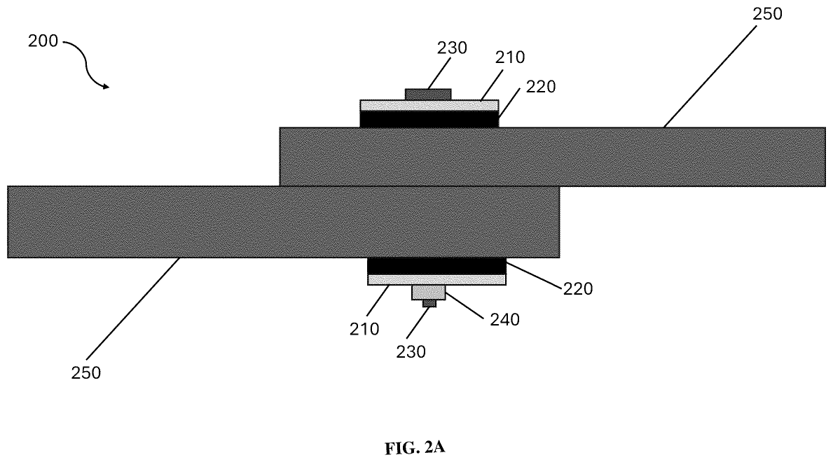

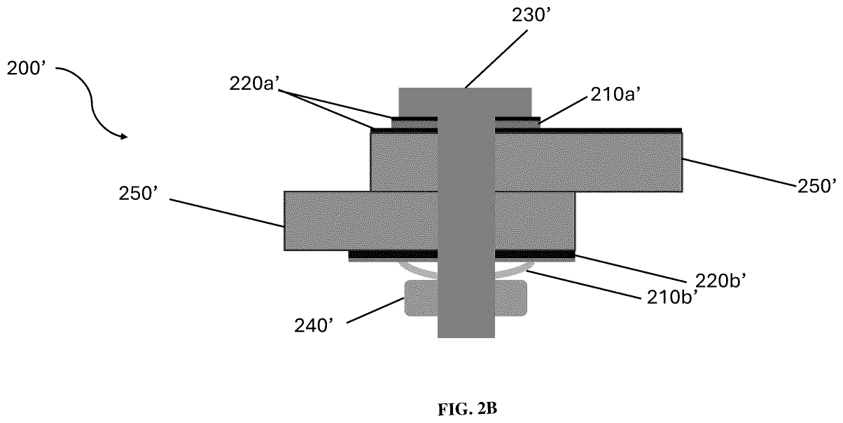

For example, FIG. 2A shows a non-limiting schematic of a joint 200 including two connector devices 210, such as a washer, having elastic coating materials 220 thereon, a bolt 230, a nut 240, where the connector devices, bolt, and nut form the joint connecting bus bars 250. It is further understood from FIG. 2A that, in some instances, the interface may include a further (third) object, such as where the bottom coated connector device (i.e., washer) has bolt 230 going through the hole of the washer and is also in contact with nut 240. FIG. 2A is a non-limiting representation of a bus bar bolted connection.

In some instances, the connector device is a washer. In some instances, the washer is selected from the group consisting of belleville washers, spring washers, lock washers, fender washers, flat washers, split lock washers, wave washers, internal tooth lock washers, external tooth lock washers, shoulder washers, countersunk washers, sealing washers, torque washers, tab washers, spherical washers, dome washers, cup washers, square washers, and dock washers.

In some instances, the first object is a fastener, such as a bolt, a nut, a clamp, a clip, or a rivet. In some instances, the second object is a bus bar, such as made of copper, brass, or aluminum; or wherein the second object is a flange or plate, such as made of copper, brass, aluminum, steel, iron, poly(vinyl chloride) (PVC), acrylonitrile butadiene styrene (ABS), high-density polyethylene (HDPE), or high impact polystyrene (HIPS).

In some instances, the elastic coating material can deform elastically under a load of about 10 to 100 psi, 100 to 30,000 psi, 5,000 to 30,000 psi, or 100 to 5000 psi. In some instances, the elastic coating material has an elastic compression and elastic recovery/rebound to maintain a load on the first and second object's surfaces. In some instances, the elastic coating material has an elastic shear deformation which can accommodate lateral strain(s) of the second object's surface without translating all of the shear load to the first object, where the transverse expansion and compression can be within a range of 1 to 100 um, 100 to 1000 or 1000 to 10000 um, as well as sub-ranges or individual values contained within the aforementioned ranges.

In some instances, the joint is under a torque load. In some instances, the joint is under a normal load (i.e., clamping force). In some instances, the elastic coating material can absorb or dampen vibrations, such as due to electromagnetic field oscillations or due to cyclical mechanical action, shocks, and/or resist thermal expansion of the first object and/or the second object to prevent or reduce a loss of the torque load over a period of time, and/or to prevent or reduce permanent deformation, creep, or stress relaxation of the first object and/or the second object from additional load on the joint over a period of time, as compared to a joint with a connector device that does not include any coating thereon. In some instances, the elastic coating material can absorb or dampen vibrations due to electromagnetic field oscillations or due to cyclical mechanical action, shocks, and/or resist thermal expansion of the first object and/or the second object to prevent or reduce a loss of the torque load over a period of time and eliminates or minimizes the need to re-torque (i.e., re-tightening) of, for instance, a bolt/fastener, as compared to an equivalent instance but in the absence of the elastic coating material being present. Loosening of a bolt/fastener may be evaluated by junker testing, which is an accelerated test designed to compare bolt loosening such as under test standard DIN25201 at 12 Hz per second vibration.

In some instances, the thickness of the elastic coating material, as described above, is selected to dampen vibration(s) and absorb stress(es) resulting from thermal shock at the interfaces, such as the bus bar bolted connection, where a thicker elastic coating material thickness (i.e., greater than 100 microns in thickness) may be preferred.

In some other instances, the thickness of the elastic coating material, as described above, is selected to reduce thermal resistance from bar to bolt and the thermal gradient between the bolt head and the bar, such as in the bus bar bolted connection, where a thinner elastic coating material thickness (i.e., less than 100 microns in thickness) may be preferred. In such instances, a thinner elastic coating material thickness can provide for radiative heat transfer away from the bar surface which lowers the bar temperature and a need for excess conductor mass. For example, FIG. 2B shows a non-limiting illustration of a joint 200′ including two connector devices 210a′ (washer) and 210′b (fender washer) each having elastic coating materials 220a′ and 220b′ thereon, a bolt 230′, a nut 240′, where the connector devices, bolt, and nut form the joint connecting bus bars 250′. In the case of washer 210a′, the elastic coating material 220a′ is thin coating present on both sides of the washer and the coating contacting the bus bar optionally extends beyond just the surface of the washer and out over the surface of the bus bar. In the case of the fender washer 210b′, the elastic coating material 220b′ is thick coating.

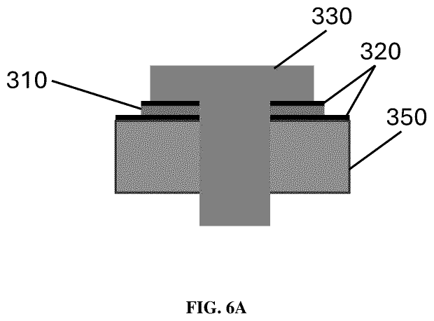

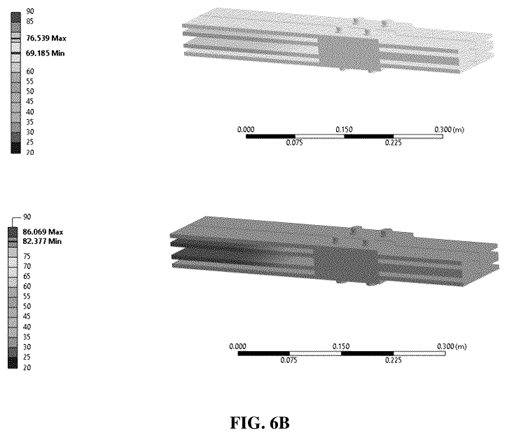

In some instances, the thickness of the elastic coating material, as described above, provides increased thermal contact conductance between interfaces, such as from a bus bar to bolt, where a thinner elastic coating material thickness (i.e., less than 100 microns in thickness) may be preferred. Thus, a thinner elastic coating material can be used for maximizing heat transfer at an interface, such as from a bus bar to a bolt, to reduce thermal gradients and stress build due to mismatch between heated bar and cooler bolt, as well as temperature rise, as compared to a “dry contact” metal-to-metal bolted interface absent any elastic coating material. In some instances, the coated connector device (i.e., washer) has an elastic coating material on two surfaces, such as a surface interfacing a bolt to the washer and a surface interfacing the washer to a bus bar (see FIG. 6A). Thus, in some instances, there is a reduction in a temperature mismatch at a joint between a first object (such as a bolt) and a second object (such as a bus bar) that provides for effective heat rejection via radiation.

In some instances, the thickness of the elastic coating material, as described above, provides a thermal contact conductance (W/m²-K) between interfaces, such as from a bus bar to bolt, where a thinner elastic coating material thickness (i.e., less than 100 microns in thickness) in a range from between about 10,000 to 25,000 W/m²-K under a pressure load of about 0.5 MPa (72 psi) or in a range from between about 45,000 to 50,000 W/m²-K under a pressure load of about 13 MPa (2000 psi). Such thermal contact conductance values can be about 2 to 30 times greater, as compared to a “dry contact” metal-to-metal interface any elastic coating material.

In some instances, the elastic coating material eliminates or reduces the loss of torque load by at least about 0.1% to 99.9%, 1 to 5%, 5 to 10%, 10 to 25%, or 25 to 50% over the period of time. In some instances, the period of time is at least about 1, 2, 3, 4, 5, 6, 7, 8, 9, 10, 11, or 12 months, as well as individual values or sub-ranges contained within the aforementioned ranges. In some instances, the period of time is at least about 1 to 5 years, 1 to 4 years, 1 to 3 years, or 1 to 2 years, as well as individual values or sub-ranges contained within the aforementioned ranges. In some instances, the elastic coating material can reduce a loss of torque load or normal load such that any loss experienced at the joint results in a residual torque or clamping load that remains and is sufficient to provide a clamping load required to carry an electrical current through the fastened joint when subjected to, for example UL 1558 short circuit testing.

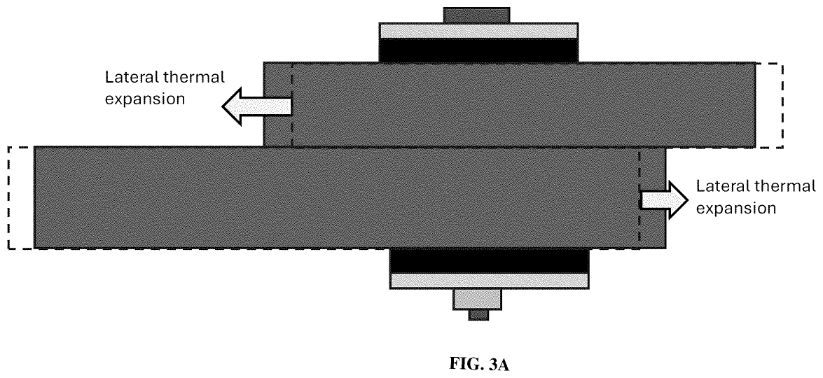

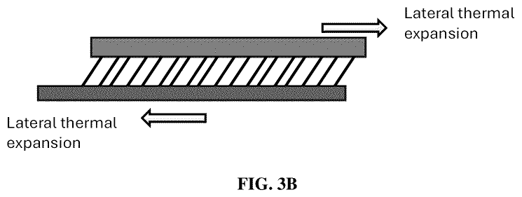

In some instances, the elastic coating material of the connector device reduces thermal expansion forces, such as movements and/or shear forces and/or axial forces, which occur at the interface between the first and the second objects, as compared to a joint with a connector device that does not include any coating thereon. For instance, FIG. 3A shows a non-limiting illustration of a joint under lateral thermal expansion forces. Moreover, FIG. 3B shows a non-limiting illustration of an interface 300 of a joint, as described herein, which is under lateral thermal expansion forces, where an elastic coating material including aligned nanostructures (such as carbon nanotubes) is present at the interface 300 between a connector device and an object and the nanotubes can bend elastically to accommodate movement and in-plane shear forces while maintaining contact with the joint. Such nanostructures can handle shearing due to lateral thermal expansion of, for example, a heated bus bar, as shown in FIG. 3A.

In some instances, the elastic coating material reduces, eliminates, or relaxes stresses at the interface between the first and the second objects, as compared to a joint with a connector device that does not include any coating thereon.

In some instances, the elastic coating material extends beyond the total surface of a connector device, such as a washer, interfacing another object, such as bus bar. Such an example is shown in FIG. 6A, where an elastic coating at the interface between a washer and bus bar extends out to cover all or at least a portion of the surface of the bus bar. In such cases, the elastic material over the (entire) surface of the bus bar can provide for a radiative cooling effect and can reduce the temperature rise thereof. In some instances, such as when the elastic coating material includes carbon nanostructures like aligned graphene, aligned carbon nanotubes, aligned carbon nanofibers, and/or other alignable materials (such as silica, boron nitride, copper, or silver nanowires) therein, this can dissipate heat through radiative heat transfer at a high rate. Accordingly, by coating an object, such as a busbar surface with such a coating improved emissivity can result in significant temperature reductions.

In some instances, where the joint is a bus bar bolted electrical connection, such as shown in FIG. 2B, the inclusion of the maintaining elastic coating material allows for maintaining a load and surviving electrical shorts, or other electromechanical sources of failure, at the joint compared to an equivalent joint absent any coating material present. For example, a higher current short may undergo more thermal expansion, where in such instances a thicker might be useful and preferred.

In some instances, where the joint is a bus bar bolted electrical connection, such a joint may have greater than two bus bars stacked therein.

Joints can be formed by various methods. In one non-limiting instance, a method of forming a joint includes the steps of:
(a′) placing a coated connector device, as described herein, in between a first object and a second object;
wherein the connector device interfaces the first object and the second object.

In some instances, the method above further includes a step of applying a torque load to the joint through the first object. In some instances, the torque load applied is in a range of about 1 to 500 in-lb, 5 to 50 in-lb, 50 to 100 in-lb 100 to 500 in-lb or 500 to 1,000 in-lb, as well as individual values or sub-ranges contained within the aforementioned ranges.

In some instances, the method above further includes a step of applying a normal load or clamping load to the joint through the first object. In some instances, the normal load or clamping load applied is in a range of about 0.1 to 1 kN, 0.1 to 2.5 kN, 0.1 to 5 kN, 0.1 to 7.5 kN, 0.1 to 10 kN, 0.1 to 12.5 kN, 0.1 to 15 kN, 0.1 to 17.5 kN, 0.1 to 20 kN, 0.1 to 22.5 kN, 0.1 to 25 kN, 0.1 to 27.5 kN, 0.1 to 30 kN, 0.1 to 32.5 kN, or 0.1 to 35 kN, as well as individual values or sub-ranges contained within the aforementioned ranges.

In some instances, the joints described herein can be broken or taken apart as needed. In one non-limiting case, a method of breaking a joint, where the joint includes:
a first object; and
a second object;
wherein the connector device, as described herein, interfaces the first object and the second object; the method includes the step of:
(a″) separating the connector device, the first object, and the second object.

In some instances, the above method further includes the step of removing any torque load which may be present on the connector device, the first object, and the second object prior to step (a″).

In some instances, a device or component can include a connector device as described herein, where the device or component is optionally an electronic device or electronic component.

The present invention will be further understood by reference to the following non-limiting examples.

### EXAMPLES

### Example 1: Coated Connector Devices

### Materials:

(1) A thick elastic coating material, which is on a connector device like a washer, included a 250 um thick coating made from 100 um of vertically aligned carbon nanotube arrays on both sides of 50 um foil in between. Another example of thick elastic coating material was a stack of four vertically aligned carbon nanotube arrays, where each array had a total thickness of 90 um pad being formed from a 50 um foil having 40 um of carbon nanotubes (20 um per side, nominally). The four stack then has about 160 um of CNTs, nominally.
(2) For enhancing radiation from an object, such as a bus bar, and improving thermal contact between a bolt head and the bus bar, a thin elastic coating material, which is on a connector device like a washer, included a 65 um coating made from a 50 um foil having a 15 um vertically aligned carbon nanotube array thereon; or a 90 um thick coating.

The aforementioned elastic coating materials containing vertically aligned carbon nanotube arrays on foil substrates were prepared according to methods described above.

### RESULTS AND DISCUSSION

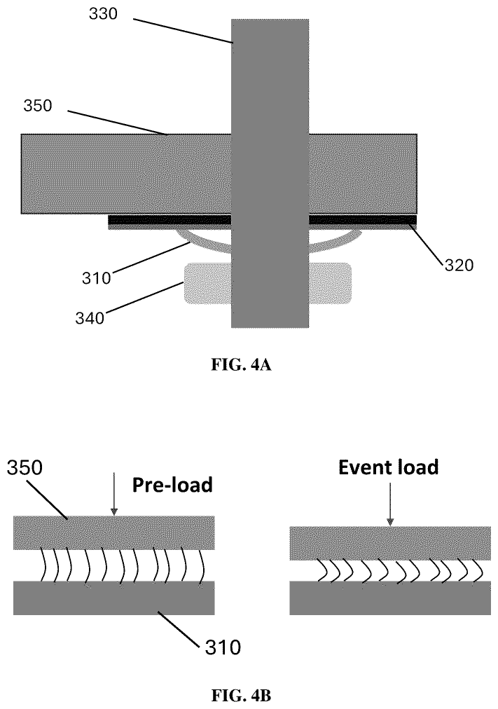

Evaluation of a coated connector device, such as a fender washer, at an interface with a bus bar, as shown in FIG. 4A where the presence of the elastic material coating can absorb stress and dampen vibrations, resulting in a reduction/elimination of the probability of a need for retorque at the bolter bus bar connection. As shown in FIG. 4B, the elastic material coating between the bus bar and the washer includes aligned carbon nanotubes.

Modeling results arising from coupon testing for typical nominal fastener preload and remaining compression in the coated connector for various coated connector devices are shown in Table 1 below.

TABLE 1

| Nominal | Coating Dimensions | | Nominal | Remaining |
|---|---|---|---|---|
| Bolt | Inner diameter | Outer diameter | Preload | Compression |
| Size | D [symbol] (mm) | D [symbol] (mm) | (kN) | (μm) |
| M8 | 8.4 | 50 | 10.0-14.3 | 26-36 |
| M10 | 10.5 | 50 | 15.0-22. [symbol] | 20- [symbol] |
| M12 | [symbol] | 50 | 20.8-32.9 | 20-36 |
| M12 | [symbol] | 60 | 20.8-32.9 | [symbol] -36 |
| M14 | [symbol] | 50 | 17.8-2 [symbol] | [symbol] -34 |
| M14 | [symbol] | 60 | 17.8-2 [symbol] | 34-46 |

[symbol]

indicates data missing or illegible when filed

The coated connector device exhibited additional remaining compression even when the nominal preload force was exceeded. The ability to remain elastic at such forces showed the benefit of the presence of the elastic material coating and that the material can be used to supplement or replace commonly used conical washers. This behavior may stem from the tendency to increase in effective compressive modulus with increasing load applied, preserving the connectors ability to compress further without exceeding the yield strength of the fastening device, or reducing the degree to which the yield strength is exceeded.

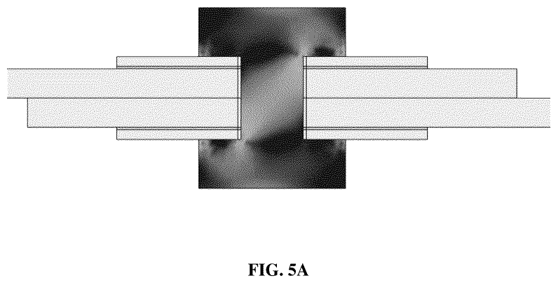

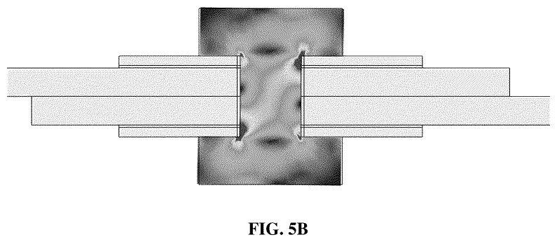

Further, the presence of the elastic material coating at the washer-to-bar interface was able to relieve stress concentrations that build up during thermal shock events (i.e. large expansion of the bars) and dampen vibrations. For instance, as shown in the theoretical analyses in FIGS. 5A and 5B, there was an approximately 3× reduction of the peak stress due to the presence of the elastic interface resulting from the coating material (FIG. 5A), as compared to in the absence thereof (FIG. 5B).

Further, a thin elastic coating material can be used to maximize heat transfer from the bus bar to the bolt to reduce thermal gradients and stress build due to mismatch between heated bar and cooler bolt, as well as temperature rise. As shown in FIG. 6A, a joint including a connector device 310, such as a washer, having two thin elastic coating materials 320 thereon, a bolt 330, where the connector device, bolt, and a nut (not shown) can form a joint connecting bus bars, such as 350.

Modeling results arising from coupon testing on heat transfer characteristics for a joint of FIG. 6A are shown in Table 2 below.

TABLE 2

| | Thermal Contact Conductance (W/m2-K) | |
|---|---|---|
| | 0.5 MPa (72 psi) | 13 MPa (2000 psi) |
| Copper-Stainless Steel | 600-2,800 | 5,000-25,000 |
| Thin Elastic Coating | 19,000 | 50,000 |
| (65 microns) | | |

Thermal resistance improvement was found when a thin elastic coating material (such as of 65 microns) was included at the interfaces between the washer and bus bar, as compared to a direct copper-stainless steel interface without the presence of a coating material between. This showed that the elastic coating material can improve thermal conductance relative to a “dry contact” metal-to-metal bolted interface.

Further, as shown in FIG. 6A, extending the elastic coating material to cover the entire surface of the bus bar provided a notable effect in the radiative cooling thereof. For example, FIG. 6B shows two heat dissipation simulations of bus bar bolted assemblies with (top) and without (bottom) an elastic coating material across the entire bus bar surface.

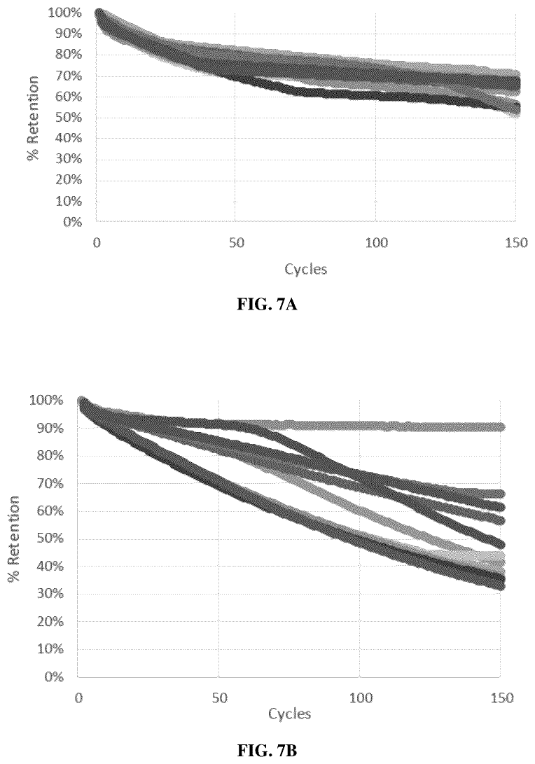

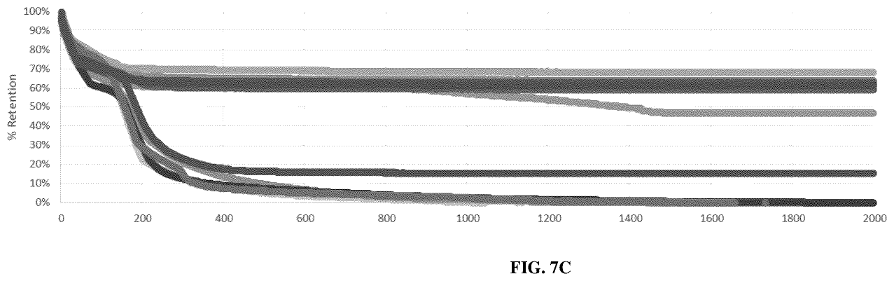

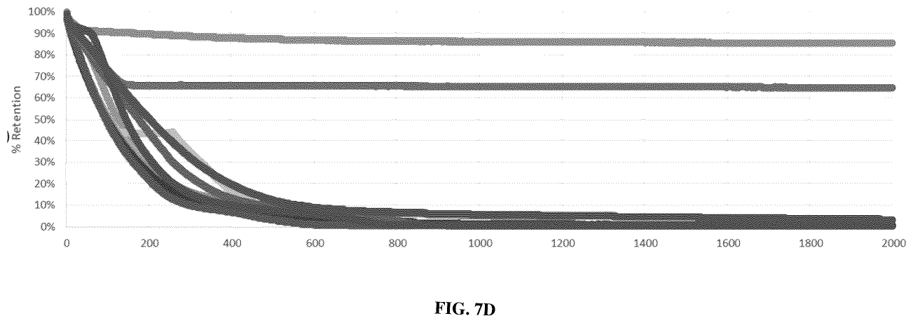

Lastly, accelerated modeling was performed to evaluate resistance to torque loss and bolt loosening by Junker testing (Test standard—DIN25201; 12 Hz per second vibration). A washer having an elastic coating material thereon was compared to a belleville+washer (without such a coating present). As shown in FIGS. 7A and 7B, the inclusion of the elastic coating material on the washer allowed for retention of greater than 50% of the applied preload for up to 150 cycles (at 12 Hz per second) for various samples tested, as compared to the belleville+washer (without such a coating present). As shown in FIGS. 7C and 7D, the inclusion of the elastic coating material on the washer allowed for at least 3× greater retention of the applied preload for up to 2000 cycles (at 12 Hz per second) for 11 samples tested, as compared to the belleville+washer (without such a coating present). With the presence of the elastic coating materials 6 of 11 samples (55%) retained preload, whereas in the absence only 2 of 11 samples (18%) retained pre-load.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific instances of the invention described herein. Such equivalents are intended to be encompassed by the following claims.

We claim:

1. A connector device, the connector device comprising:
an elastic coating material on at least one surface portion of the connector device;
wherein the connector device can interface a first object and a second object and the elastic coating material is capable of contacting a surface of at least the first or the second object.

2. The connector device of claim 1, wherein the connector device is a washer optionally selected from the group consisting of belleville washers, spring washers, lock washers, fender washers, flat washers, split lock washers, wave washers, internal tooth lock washers, external tooth lock washers, shoulder washers, countersunk washers, sealing washers, torque washers, tab washers, spherical washers, dome washers, cup washers, square washers, and dock washers.

3. The connector device of claim 1, wherein the connector device is under a torque or normal load when interfacing the first object and the second object.

4. The connector device of claim 3, wherein the elastic coating material can absorb or dampen vibrations, shocks, and/or resist thermal expansion of the first object and/or the second object to prevent or reduce a loss of the torque load over a period of time, or to prevent or reduce permanent deformation, creep, or stress relaxation of the first object and/or the second object from additional load on the joint over a period of time, as compared to a connector device that does not comprise any coating thereon.

5. The connector device of claim 3, wherein the elastic coating material eliminates or reduces the loss of torque load by at least about 0.1% to 99.9%, 1 to 5%, 5 to 10%, 10 to 25%, or 25 to 50% over the period of time.

6. The connector device of claim 1, wherein the elastic coating material comprises an elastic polymer or elastomer, such as selected from such as rubbers, silicones, polyurethane, styrene-ethylene-butylene-styrene (SEBS), styrene-butadiene rubber (SBR), nitrile butadiene rubber (NBR), ethylene propylene diene monomer rubber (EPDM), or polyisoprene.

7. The connector device of claim 1, wherein the elastic coating material comprises a polymer composite, such as made from a combination of an elastomer and a reinforcing elastic material.

8. The connector device of claim 1, wherein the elastic coating material comprises nanostructures optionally selected from aligned graphene, aligned carbon nanotubes, and/or aligned carbon nanofibers.

9. The connector device of claim 1, wherein the elastic coating material comprises at least a first layer or tier comprising a carbon nanotube array or sheet.

10. The connector device of claim 9, further comprising a coating material on at least some of the interstitial space between the carbon nanotubes of the carbon nanotube array or sheet.

11. The connector device of claim 10, wherein the coating material encapsulates the carbon nanotubes of the carbon nanotube array or sheet; and
the coating material is optionally an elastic polymer or elastomer.

12. The connector device of claim 9, wherein the elastic coating material comprises at least a second layer or tier comprising a carbon nanotube array or sheet,
wherein the carbon nanotubes of the array or sheet of the first layer or tier at least partially interdigitate the carbon nanotubes of the array or sheet of the second layer or tier to form a multilayered or multitiered structure.

13. The connector device of claim 1, wherein the elastic coating material of the connector device reduces thermal expansion forces, such as movements and/or shear forces and/or axial forces, which occur at the interface between the first and the second objects, as compared to a connector device that does not comprise any coating thereon.

14. The connector device of claim 1, wherein the elastic coating material reduces, eliminates, or relaxes stresses at the interface between the first and the second objects, as compared to a connector device that does not comprise any coating thereon.

15. The connector device of claim 1, wherein the elastic coating material reduces galvanic corrosion.

16. A method of forming the connector device of claim 1, comprising the steps of:
(a) applying an elastic coating material onto at least one surface portion of a connector device;
wherein the connector device can interface a first object and a second object and the coating is capable of contacting at least the first or the second object's surface.

17. The method of claim 16, wherein the elastic coating material comprises an elastic polymer or elastomer, such as selected from such as rubbers, silicones, polyurethane, styrene-ethylene-butylene-styrene (SEBS), styrene-butadiene rubber (SBR), nitrile butadiene rubber (NBR), ethylene propylene diene monomer rubber (EPDM), or polyisoprene.

18. The method of claim 16, wherein the elastic coating material comprises a polymer composite, such as made from a combination of an elastomer and a reinforcing elastic material (such as nanotubes or fibers made of carbon, metals, or ceramics).

19. The method of claim 16, wherein the elastic coating material comprises carbon nanostructures optionally selected from aligned graphene, aligned carbon nanotubes, and/or aligned carbon nanofibers.

20. The method of claim 16, wherein the elastic coating material comprises at least a first layer or tier comprising a carbon nanotube array or sheet.

21. The method of claim 20, further comprising a coating material on at least some of the interstitial space between the carbon nanotubes of the carbon nanotube array or sheet.

22. The connector device of claim 21, wherein a coating material encapsulates the carbon nanotubes of the carbon nanotube array or sheet; and the coating material is optionally an elastic polymer or elastomer.

23. The connector device of claim 20, wherein the elastic coating material comprises at least a second layer or tier comprising a carbon nanotube array or sheet,
wherein the carbon nanotubes of the array or sheet of the first layer or tier at least partially interdigitate the carbon nanotubes of the array or sheet of the second layer or tier to form a multilayered or multitiered structure.

24. The method of claim 16, wherein the connector device is a washer.

25. A joint comprising:
a first object; and
a second object;
wherein the connector device of claim 1 interfaces the first object and the second object.

26. The joint of claim 25, wherein the connector device is a washer.

27. The joint of claim 25, wherein the first object is a fastener, such as a bolt, a nut, a clamp, a clip, or a rivet.

28. The joint of claim 25, wherein the second object is a bus bar, such as made of copper, brass, or aluminum; or wherein the second object is a flange or plate, such as made of copper, brass, aluminum, steel, iron, poly(vinyl chloride) (PVC), acrylonitrile butadiene styrene (ABS), high-density polyethylene (HDPE), or high impact polystyrene (HIPS).

29. The joint of claim 25, wherein the joint is under a torque load or normal load.

30. The joint of claim 29, wherein the elastic coating material can absorb or dampen vibrations, shocks, and/or resist thermal expansion of the first object and/or the second object to prevent or reduce a loss of the torque load over a period of time, or to prevent or reduce permanent deformation, creep, or stress relaxation of the first object and/or the second object from additional load on the joint over a period of time, as compared to a joint with a connector device that does not comprise any coating thereon.

31. A method of forming a joint, the method comprising the steps of:
(a′) placing a connector device of claim 1 in between a first object and a second object;
wherein the connector device interfaces the first object and the second object.

32. The method of claim 31, further comprising a step of applying a torque load or normal load to the joint through the first object.

33. The method of claim 32, wherein there is a reduction in a temperature mismatch between the first object and the second object that provides for heat rejection via radiation.
